(19) United States
(12) Patent Application Publication
(10) Pub. No.: US 2004/0014449 A1
(43) Pub. Date: Jan. 22, 2004

(54) Radio interference suppression circuit and method, antenna multiplexer, transceiver circuit, and communication apparatus

(76) Inventors: Hisashi Adachi, Osaka (JP); Kaoru Ishida, Osaka (JP); Makoto Sakakura, Uji-shi (JP)

Correspondence Address: RATNERPRESTIA, P O BOX 980, VALLEY FORGE, PA, 19482-0980, US

(21) Appl. No.: 10/391,668

(22) Filed: Mar. 19, 2003

(30) Foreign Application Priority Data
Mar. 19, 2002 (JP) 2002-077003

(51) Int. Cl. H04B 1/10

(52) U.S. Cl. 455/296; 455/63.1

(57) ABSTRACT

A radio interference suppression circuit used in a radio circuit of performing duplex transmission, comprises a first directional coupler of receiving a transmission frequency signal and then bifurcating and outputting the signal; and a second directional coupler which acquires, through one input thereof, a signal outputted from a reception filter of an antenna multiplexer and containing a reception frequency signal and the leakage signal component of a transmission frequency signal, and acquires, through the other input thereof, the transmission frequency signal outputted from one output of the first directional coupler, and which combines and outputs these acquired signals; wherein the leakage signal component of the transmission frequency signal contained in the signal inputted through the one input of the second directional coupler and the transmission frequency signal inputted through the other input of the second directional coupler are adjusted to be substantially of equal amplitude and reversed phase.

### DETAILED DESCRIPTION OF THE INVENTION

1. Field of the Invention

The present invention relates to a radio interference suppression circuit and method used in a communication apparatus for mobile communication and the like, and to an antenna multiplexer, a transceiver circuit, and a communication apparatus using the same.

2. Related Art of the Invention

Various schemes are used in radio communication using mobile communication terminals such as cellular phones. Among such radio communication schemes, in a scheme such as W-CDMA, a transmission frequency and a reception frequency are respectively selected from different frequency bands, whereby radio communication is performed in the form of duplex transmission where transmission and reception are performed simultaneously.

FIG. 4 shows the configuration of a cellular phone terminal 27 serving as an example of a communication apparatus of performing radio communication according to such a radio communication scheme which implements duplex transmission.

The cellular phone terminal 27 comprises a transmitting circuit 26, a receiving circuit 3, a local oscillator 4, an antenna multiplexer 6, and an antenna 7.

The transmitting circuit 26 modulates a baseband signal outputted from a baseband section (not shown), and thereby outputs a transmission signal. Transmitting circuit 26 comprises a modulator 8, a mixer 9, a band pass filter 10, a power amplifier 11, and an isolator 25.

The receiving circuit 3 acquires a reception signal outputted from the antenna multiplexer 6, thereby demodulates the acquired reception signal, and then outputs a baseband signal to the baseband section (not shown). The receiving circuit 3 comprises a low-noise amplifier 13, a band pass filter 14, a mixer 15, a band pass filter 16, and a demodulator 17.

The local oscillator 4 provides a local oscillation signal to the mixers 9 and 15.

The antenna multiplexer 6 transfers a transmission signal outputted from the transmitting circuit 26, to the antenna 7, and at the same time, transfers a reception signal received by the antenna 7, to the receiving circuit 3. The antenna multiplexer 6 comprises a transmission filter 23 which transfers transmission signals but does not transfer reception signals and a reception filter 24 which transfers reception signals but does not transfer transmission signals.

Described below is the operation of this prior art cellular phone terminal 27.

The cellular phone terminal 27 performs duplex transmission where transmission and reception are performed simultaneously.

The operation of transmission is described below first. The modulator 8 modulates an inputted carrier wave with a baseband signal outputted from the baseband section (not shown), and thereby outputs an intermediate frequency signal. The mixer 9 combines the local oscillation signal outputted from the local oscillator 4 and the intermediate frequency signal outputted from the modulator 8, into a transmission frequency signal. Unnecessary frequency components in the transmission frequency signal outputted from the mixer 9 are reduced by the band pass filter 10. Then, the transmission frequency signal is amplified by the power amplifier 11.

The transmission frequency signal amplified by the power amplifier 11 passes through the isolator 25, and then goes to the transmission filter 23 of the antenna multiplexer 6.

The transmission frequency signal having reached the transmission filter 23 passes through the transmission filter 23, and then reaches the antenna 7, while a part of this signal goes to the reception filter 24. However, the frequency of the transmission frequency signal is outside the pass band of the reception filter 24, and hence the transmission frequency signal does not pass through the reception filter 24. As a result, the transmission frequency signal is provided exclusively to the antenna 7, and then radiated as a transmission wave from the antenna 7 to the air. As such, transmission waves are transmitted.

At the same time as this transmission, the cellular phone terminal 27 performs reception. The operation of reception is described below.

A reception frequency signal received by the antenna 7 is provided to the antenna multiplexer 6. The reception frequency signal provided to the antenna multiplexer 6 is then provided to the reception filter 24, as well as to the transmission filter 23. The frequency of the reception frequency signal is outside the pass band of the transmission filter 23, and hence the reception frequency signal does not pass through the transmission filter 23. In contrast, the frequency of the reception frequency signal is within the pass band of the reception filter 24, and hence the reception frequency signal passes through the reception filter 24. As a result, the reception frequency signal received by the antenna 7 is provided through the reception filter 24 to the low-noise amplifier 13.

The low-noise amplifier 13 amplifies the inputted reception frequency signal, and then outputs the signal to the band pass filter 14. Unnecessary frequency components in the reception frequency signal inputted to the band pass filter 14 are reduced here. The reception frequency signal is then provided to the mixer 15. The mixer 15 combines the local oscillation signal inputted from the local oscillator 4 and the reception frequency signal inputted from the band pass filter 14, into an intermediate frequency signal. Distortion components in the intermediate frequency signal outputted from the mixer 15 are reduced by the band pass filter 16. Then, the intermediate frequency signal is provided to the demodulator 17, and thereby demodulated into a baseband signal in the demodulator 17. The demodulated baseband signal is provided to the baseband section (not shown).

As such, the antenna multiplexer 6of the prior art cellular phone terminal 27, FIG. 1, transfers a transmission signal to the antenna 7, but prevents the transmission signal from leaking into the receiving circuit 3. At the same time, the antenna multiplexer 6 transfers a reception signal received by the antenna 7 to the receiving circuit 3, but prevents the reception signal from leaking into the transmitting circuit 26.

FIG. 2(a) shows a reception filter characteristic 31 and a transmission filter characteristic 32 which are the pass characteristics of the reception filter 24 and the transmission filter 23, respectively, for the case that the transmission frequency ftx and the reception frequency frx are separated sufficiently.

As seen from FIG. 2(a), the reception filter characteristic 31 has a low passage loss at the reception frequency frx and a sufficiently high attenuation at the transmission frequency ftx. On the other hand, the transmission filter characteristic 32 has a low passage loss at the transmission frequency ftx and a sufficiently high attenuation at the reception frequency frx.

In contrast, FIG. 2(b) shows a reception filter characteristic 33 and a transmission filter characteristic 34 which are the pass characteristics of the reception filter 24 and the transmission filter 23, respectively, for the case that the transmission frequency ftx and the reception frequency frx are close to each other.

As seen from FIG. 2(b), the reception filter characteristic 33 has a low passage loss at the reception frequency frx but an insufficient attenuation at the transmission frequency ftx. On the other hand, the transmission filter characteristic 34 has a low passage loss at the transmission frequency ftx but an insufficient attenuation at the reception frequency frx.

Accordingly, in this case, a part of the reception frequency signal received by the antenna 7 passes through the transmission filter 23, and thereby leaks into the transmitting circuit 26. Similarly, a part of the transmission frequency signal outputted from the transmitting circuit 26 passes through the reception filter 24, and thereby leaks into the receiving circuit 3.

However, the reception frequency signal is weaker than the transmission frequency signal. Accordingly, the reception frequency signal having leaked into the transmitting circuit 26 is sufficiently reduced on the band pass filter 10 side by the isolator 25 in the transmitting circuit 26.

In contrast, the transmission frequency signal generally has a higher power than the reception frequency signal. Accordingly, the transmission frequency signal having leaked into the receiving circuit 3 has substantial influence to the circuit. Further, no isolator can be provided in the receiving circuit 3.

Thus, the transmission frequency signal having leaked into the receiving circuit 3 serves as an interference wave to the received wave, and thereby causes saturation to the low-noise amplifier 13. Alternatively, the signal is amplified by the low-noise amplifier 13, and thereby causes saturation to the mixer 15. When the low-noise amplifier 13 or the mixer 15 is saturated, the gain of the amplification is suppressed, whereby the NF (noise figure) of the reception performance is degraded.

As such, in a communication scheme in which duplex transmission is performed in all or part of the communication, there has been a problem that when the transmission frequency and the reception frequency are somewhat close to each other, the transmission frequency signal leaks into the receiving circuit.

As an alternative approach of solving this problem, in case that the attenuation characteristic of the reception filter 24 of the multiplexer 6 is made steeper with maintaining the size of the filter, the reception loss of the filter increases at the reception frequency. In contrast, in case that the attenuation characteristic of the reception filter 24 of the multiplexer 6 is made steeper with maintaining the reception loss of the filter, the size of the reception filter 24 increases.

That is, in a communication scheme in which duplex transmission is performed in all or part of the communication, for the purpose of reducing the leakage of a transmission frequency signal into a receiving circuit, in case that the attenuation characteristic of a reception filter of a multiplexer is made steeper with maintaining the size of the filter, there has been a problem that the reception loss of the filter increases at the reception frequency.

Further, in a communication scheme in which duplex transmission is performed in all or part of the communication, for the purpose of reducing the leakage of a transmission frequency signal into a receiving circuit, in case that the attenuation characteristic of a reception filter of a multiplexer is made steeper with maintaining the reception loss of the filter, there has been a problem that the size of the reception filter increases.

### SUMMARY OF THE INVENTION

Considering the above-mentioned problems, an object of the invention is to provide: a radio interference suppression circuit used in a communication scheme in which duplex transmission is performed in all or part of the communication, and capable of reducing the leakage of a transmission frequency signal into a receiving circuit; and an antenna multiplexer, a transceiver circuit, and a communication apparatus using the same.

Considering the above-mentioned problems, another object of the invention is to provide: a radio interference suppression circuit used in a communication scheme in which duplex transmission is performed in all or part of the communication, and capable of reducing the leakage of a transmission frequency signal into a receiving circuit without causing substantial increase in the reception loss at the reception frequency and in the size of a reception filter; and an antenna multiplexer, a transceiver circuit, and a communication apparatus using the same.

The 1st aspect of the present invention is a radio interference suppression circuit (5) used in a radio circuit performing duplex transmission in all or part of communication, comprising:

first branching means (18) of receiving a transmission frequency signal and then bifurcating and outputting the signal into at least two outputs at a predetermined branching ratio; and

second branching means (19) which acquires, through one input thereof, a signal containing a received reception frequency signal and the leakage signal component of a transmission frequency signal to be transmitted, and acquires, through the other input thereof, the transmission frequency signal outputted from one output of said first branching means (18), and which combines and outputs these acquired signals at a predetermined combining ratio; wherein:

a transmission frequency signal to be transmitted is outputted from another output of said first branching means (18);

the signal from said second branching means (19) is inputted to a receiving circuit (3); and

the leakage signal component of said transmission frequency signal to be transmitted which is contained in said signal inputted through the one input of said second branching means (19) and said transmission frequency signal inputted through the other input of said second branching means (19) are adjusted to be substantially of equal amplitude and reversed phase.

The 2nd aspect of the present invention is a radio interference suppression circuit (5) according to the 1st aspect, comprising a vector adjuster (21) one end of which is connected to the one output of said first branching means (18) and the other end of which is connected to the other input of said second branching means (19), whereby

said vector adjuster performs said adjustment.

The 3rd aspect of the present invention is a radio interference suppression circuit (5) according to the 2nd aspect, comprising a vector detector (22) of detecting the amplitude difference and the phase difference of a signal inputted to said radio interference suppression circuit (1), a signal from the output of said second branching means (19), a signal from the output of a low-noise amplifier (13) of said receiving circuit (3), or a signal from any circuit portion between the input of said receiving circuit (3) and an intermediate frequency converter (15) of said receiving circuit (3), relative to a signal from the one output of said first branching means (18), whereby

said vector adjuster (21) performs said adjustment on the basis of said detected amplitude difference and phase difference.

The 4th aspect of the present invention is a radio interference suppression circuit (5) according to the 3rd aspect, wherein

said vector detector (22) is composed of a quadrature demodulator, and wherein

said vector adjuster (21) is composed of a quadrature modulator.

The 5th aspect of the present invention is a radio interference suppression circuit (5) according to the 1st aspect, comprising controlling means of controlling said adjustment to stop when the level of said transmission signal is lower than a predetermined level.

The 6th aspect of the present invention is a radio interference suppression circuit (5) according to the 1st aspect, comprising a table of corresponding an output level and a temperature to a vector adjustment amount, whereby

said vector adjustment amount which is obtained from said table corresponding to the level of said transmission signal and to a detected temperature and which corresponds to said output level and said temperature is used as the initial value for said adjustment.

The 7th aspect of the present invention is a radio interference suppression circuit (5) according to any one of the 1st to 6th aspects, wherein said first branching means (18) comprises a directional coupler, a Wilkinson divider, a resistor divider, or a capacitive coupling.

The 8th aspect of the present invention is a radio interference suppression circuit (5) according to any one of the 1st to the 6th aspects, wherein said second branching means (19) comprises a directional coupler, a Wilkinson combiner, a resistor combiner, or a capacitive coupling.

The 9th aspect of the present invention is an antenna multiplexer (5,6) used in a radio circuit performing duplex transmission in all or part of communication, comprising:

a radio interference suppression circuit (5) according to any one of the 1st to the 6th aspects;

a transmission filter (23) connected to the other output of said first branching means (18) of said radio interference suppression circuit (5); and

a reception filter (24) connected to the input of said second branching means (19).

The 10th aspect of the present invention is a communication apparatus using a radio circuit performing duplex transmission in all or part of communication, comprising:

a transmitting circuit (2) of outputting a transmission signal;

a receiving circuit (3) of receiving a reception signal;

an antenna multiplexer (6); and

a radio interference suppression circuit (5) connected to said antenna multiplexer (6), said transmitting circuit (2), and said receiving circuit (3); wherein

said radio interference suppression circuit (5) comprises a radio interference suppression circuit according to any one of the 1st to the 6th aspects.

The 11th aspect of the present invention is a transceiver circuit (1) used in a radio circuit performing duplex transmission in all or part of communication, comprising:

a transmitting circuit of outputting a transmission signal;

a receiving circuit (3) of receiving a reception signal; and

a radio interference suppression circuit (5) connected to said transmitting circuit (2) and said receiving circuit (3); wherein

said radio interference suppression circuit (5) comprises a radio interference suppression circuit according to any one of the 1st to the 6th aspects.

The 12th aspect of the present invention is a radio interference suppression method comprising the steps of: branching a portion of a transmission frequency signal outputted from a transmitting circuit; and adding (1) a transmission frequency signal having leaked into a receiving circuit through a transmission-reception branch point which is a connection point between a transmission system and a reception system, and said branched portion of the transmission frequency signal to each other substantially with each having equal amplitude and reversed phase.

### BRIEF DESCRIPTION OF THE DRAWINGS

FIG. 1 is a configuration diagram showing a cellular phone terminal according to a first embodiment of the invention.

FIG. 2(a) is a diagram showing the filter characteristics of a transmission filter and a reception filter used in a prior art antenna multiplexer.

FIG. 2(b) is a diagram showing the filter characteristics of a transmission filter and a reception filter used in an antenna multiplexer according to a first embodiment of the invention.

FIG. 3(a) is a diagram showing the frequency distribution of a signal at an input port h of a directional coupler 18 according to a first embodiment of the invention.

FIG. 3(b) is a diagram showing the frequency distribution of a signal at an input port l of a directional coupler 19 according to a first embodiment of the invention.

FIG. 3(c) is a diagram showing the frequency distribution of a signal at an input port k of a directional coupler 19 according to a first embodiment of the invention.

FIG. 3(d) is a diagram showing the frequency distribution of a signal at an output port m of a directional coupler 19 according to a first embodiment of the invention.

FIG. 4 is a configuration diagram showing a prior art cellular phone terminal

### DESCRIPTION OF THE REFERENCE NUMERALS

1 Cellular phone terminal

2 Transmitting circuit

3 Receiving circuit

4 Local oscillator

5 Radio interference suppression circuit

6 Antenna multiplexer

7 Antenna

8 Modulator

9 Mixer

10 Band pass filter

11 Power amplifier

13 Low-noise amplifier

14 Band pass filter

15 Mixer

16 Band pass filter

17 Demodulator

23 Transmission filter

24 Reception filter

### EMBODIMENTS OF THE INVENTION

The embodiments of the invention are described below with reference to the drawings.

(First Embodiment)

Described below first is a first embodiment.

In the first embodiment, described is a radio interference suppression circuit, as well as an antenna multiplexer and a cellular phone terminal using the same.

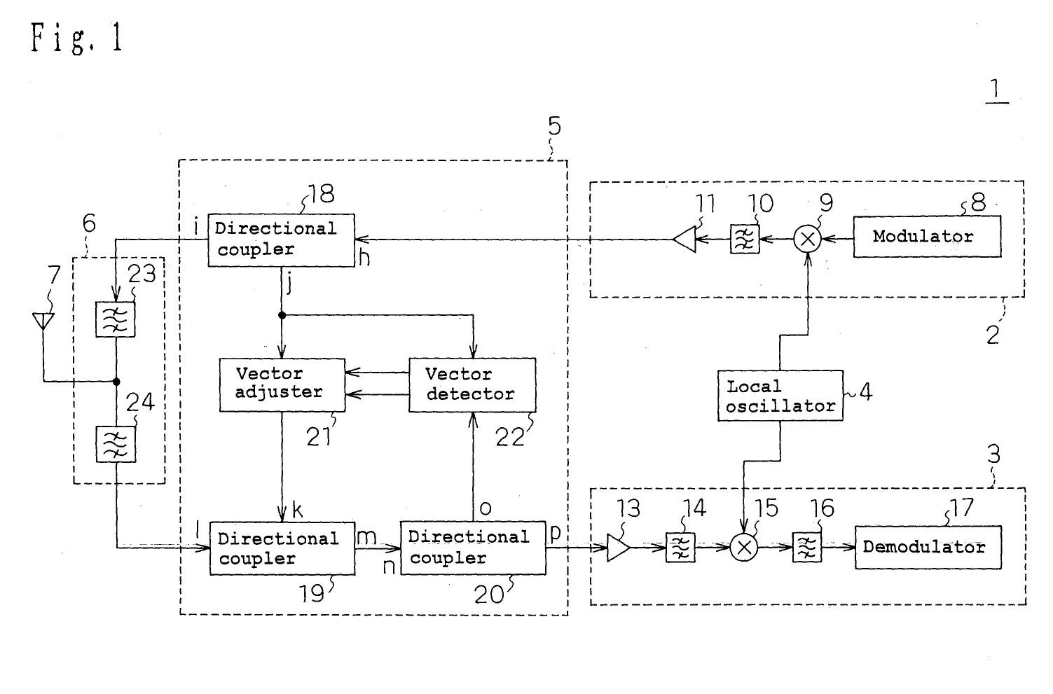

FIG. 1 shows the main part of a cellular phone terminal 1 according to the present embodiment.

Similarly to the prior art cell phone terminal 27, the cell phone terminal 1 performs radio communication by duplex transmission where transmission and reception are performed simultaneously. The radio communication scheme used is, for example, W-CDMA.

As shown in FIG. 1, the cellular phone terminal 1 according to the present embodiment comprises a transmitting circuit 2, a receiving circuit 3, a local oscillator 4, a radio interference suppression circuit 5, an antenna multiplexer 6, and an antenna 7.

The transmitting circuit 2 modulates a baseband signal outputted from a baseband section (not shown), and thereby outputs a transmission signal. Transmitting circuit 2 comprises a modulator 8, a mixer 9, a band pass filter 10, and a power amplifier 11.

The receiving circuit 3 acquires a reception signal outputted from the radio interference suppression circuit 5, thereby demodulates the acquired reception signal, and then outputs a baseband signal to the baseband section (not shown) The receiving circuit 3 comprises a low-noise amplifier 13, a band pass filter 14, a mixer 15, a band pass filter 16, and a demodulator 17.

The local oscillator 4 provides a local oscillation signal to the mixers 9 and 15.

The antenna multiplexer 6 transfers a transmission signal outputted from the transmitting circuit 2, to the antenna 7, and at the same time, transfers a reception signal received by the antenna 7, to the receiving circuit 3. The antenna multiplexer 6 comprises a transmission filter 23 which transfers transmission signals but does not transfer reception signals and a reception filter 24 which transfers reception signals but does not transfer transmission signals.

The radio interference suppression circuit 5 reduces a transmission frequency signal having leaked from the antenna multiplexer 6 into the receiving circuit 3, and reduces a reception frequency signal having leaked from the antenna multiplexer 6 into the transmitting circuit 2.

The radio interference suppression circuit 5 comprises directional couplers 18, 19, 20, a vector adjuster 21, and a vector detector 22.

The directional coupler 18 has an input port h and two output ports i and j. The directional coupler 18 bifurcates a signal inputted from the input port h, and thereby outputs the bifurcated signals respectively through the output ports i and j.

The directional coupler 19 has two input ports k and l and an output port m. The directional coupler 19 combines signals inputted from the input ports k and l, and thereby outputs the combined signal through the output port m.

The directional coupler 20 has an input port n and two output ports o and p. The directional coupler 20 bifurcates a signal inputted from the input port n, and thereby outputs the bifurcated signals respectively through the output ports o and p.

The vector adjuster 21 adjusts the amplitude and the phase of a signal inputted from the directional coupler 18, on the basis of control signals inputted from the vector detector 22.

The vector detector 22 outputs control signals which contain information on the amplitude difference and the phase difference between the signal outputted from the output port o of the directional coupler 20 and the signal outputted from the output port j of the directional coupler 18.

Each of the directional couplers 18, 19, 20 may be a bifurcated-line type directional coupler which uses magnetic coupling and electric coupling between two parallel lines, or alternatively a dense-winding coil type directional coupler in which the magnetic coupling of the bifurcated-line type directional coupler is implemented in a coupling coil. Further, each of the directional couplers 18, 19, 20 may be replaced by a Wilkinson divider (combiner), a resistor divider (combiner), a capacitive coupling, or the like.

The vector detector 22 and the vector adjuster 21 are composed of a quadrature demodulator and a quadrature modulator, respectively.

Described below is the operation of the cellular phone terminal 1 having the above-mentioned configuration according to the present embodiment.

As described above, the cellular phone terminal 1 performs duplex transmission where transmission and reception are performed simultaneously.

The operation of transmission is described below first. The modulator 8 modulates an inputted carrier wave with a baseband signal outputted from the baseband section (not shown), and thereby outputs an intermediate frequency signal. The mixer 9 combines the local oscillation signal outputted from the local oscillator 4 and the intermediate frequency signal outputted from the modulator 8, into a transmission frequency signal the frequency of which is higher than that of the intermediate frequency signal. Unnecessary frequency components in the transmission frequency signal outputted from the mixer 9 are reduced by the band pass filter 10. Then, the transmission frequency signal is amplified by the power amplifier 11. The transmission frequency signal amplified by the power amplifier 11 is provided to the radio interference suppression circuit 5.

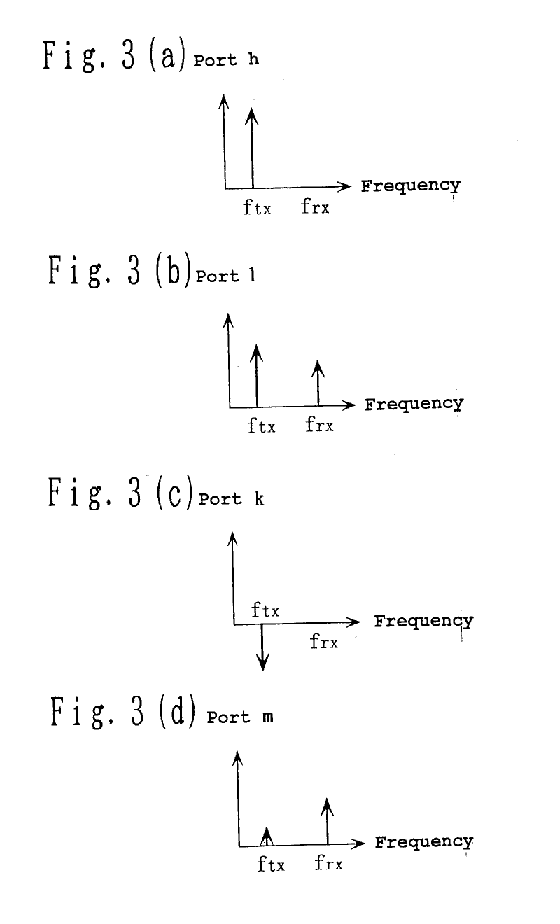

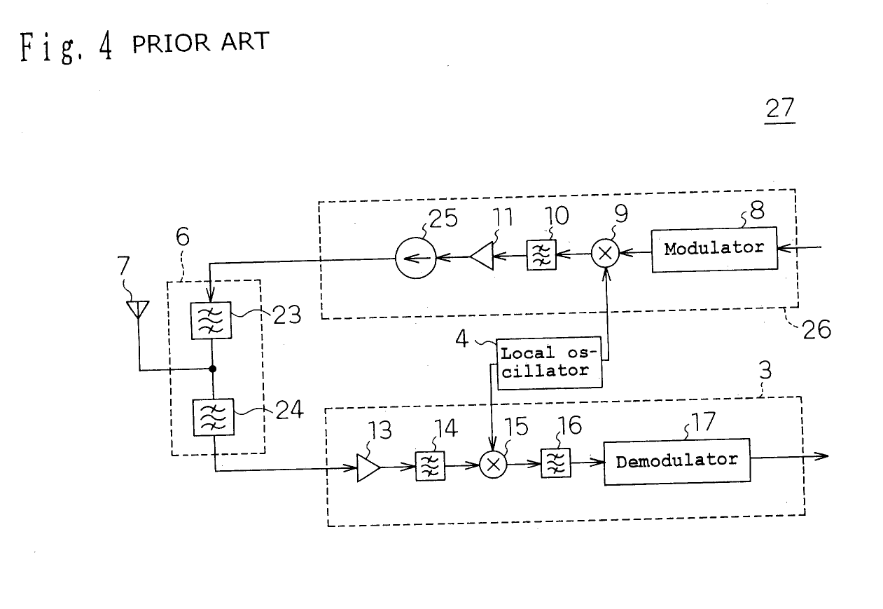

In the radio interference suppression circuit 5, the transmission frequency signal outputted from the power amplifier 11 is provided to the input port h of the directional coupler 18. FIG. 3(a) shows the frequency distribution of the transmission frequency signal at the input port h. In FIG. 3(a), frx and ftx indicate the reception frequency and the transmission frequency, respectively. The transmission frequency signal inputted through the input port h is bifurcated by the directional coupler 18, whereby these bifurcated signals are outputted respectively through the output ports i and j.

Apart of the transmission frequency signal outputted from the output port i of the directional coupler 18 passes through the transmission filter 23 of the antenna multiplexer 6, then goes through a matching circuit (not shown) provided in the antenna multiplexer 6, and then reaches the antenna 7. The signal propagates as a radio wave from the antenna 7 to the air. The other part of the transmission frequency signal goes through a matching circuit (not shown) to the reception filter 24. This part of the transmission frequency signal inputted to the reception filter 24 is partially reduced by the reception filter 24. Nevertheless, unreduced portion of the transmission frequency signal which has not been reduced by the reception filter 24 leaks through the reception filter 24 into the input port l of the directional coupler 19.

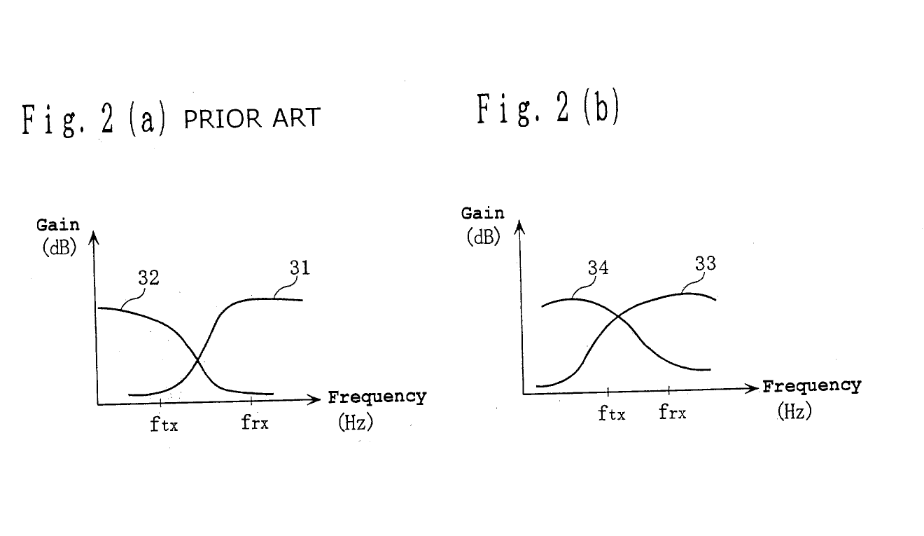

FIG. 2(b) shows a reception filter characteristic 33 and a transmission filter characteristic 34 which are the pass characteristics of the reception filter 24 and the transmission filter 23, respectively, of the antenna multiplexer 6. In FIG. 2(b), frx and ftx indicate the reception frequency and the transmission frequency, respectively. The reception filter characteristic 33 has a low passage loss at the reception frequency frx but an attenuation insufficient for the reduction of the transmission frequency signal at the transmission frequency ftx. Thus, for example, in case that the reception frequency frx and the transmission frequency ftx are close to each other, the transmission frequency signal can leak through the reception filter 24 into the input port l of the directional coupler 19. Nevertheless, even in case that the reception frequency frx and the transmission frequency ftx are separated sufficiently, the transmission frequency signal can also leak through the reception filter 24 into the input port l of the directional coupler 19 incase that sufficiently high attenuation is not obtained in the filter characteristic because of the miniaturization of the transmission filter 23 and the reception filter 24 for the purpose of the miniaturization of the cellular phone terminal 1. The transmission frequency signal having reached the input port l of the directional coupler 19 is described later in detail in the description of the operation of reception.

The other one of the bifurcated transmission frequency signals from the directional coupler 18 is outputted through the output port j to the vector adjuster 21 as well as to the vector detector 22. The vector adjuster 21 and the vector detector 22 are described later in detail in the description of the operation of reception.

At the same time as this operation of transmitting a transmission frequency signal, the cellular phone terminal 1 performs the operation of receiving a reception frequency signal through the antenna 7.

The operation of reception is described below, together with the operation of the radio interference suppression circuit 5.

A reception frequency signal received by the antenna 7 is provided to the antenna multiplexer 6. The reception frequency signal provided to the antenna multiplexer 6 is then provided through a matching circuit (not shown) to the reception filter 24, as well as to the transmission filter 23. As shown in the transmission filter characteristic 34 of FIG. 2(b), the filter characteristic of the transmission filter 23 has a low passage loss at the transmission frequency ftx but does not have a very high attenuation at the reception frequency frx. However, the reception frequency signal is weaker than the transmission frequency signal outputted from the transmitting circuit 2. Accordingly, the reception frequency signal is sufficiently reduced by the transmission filter 23. Further, even if the reception frequency signal could leak through the transmission filter 23 to the output port i of the directional coupler 18, the reception frequency signal would not substantially appear in the input port h of the directional coupler 18.

On the other hand, as shown in the reception filter characteristic 33 of FIG. 2(b), the reception filter 24 has a low passage loss at the reception frequency frx. Accordingly, the reception frequency signal having reached the reception filter 24 passes through the reception filter 24 and goes to the input port l of the directional coupler 19.

As described above in the description of the operation of transmission, at the same time that the input port l of the directional coupler 19 receives the reception frequency signal having passed through the reception filter 24, a part of the transmission frequency signal outputted from the output port i of the directional coupler 18 leaks through the reception filter 24 into the input port l of the directional coupler 19.

FIG. 3(b) shows the frequency distribution of the signal at the input port l of the directional coupler 19. As seen from FIG. 3(b), in the input port l of the directional coupler 19, signal components are distributed at the reception frequency frx and the transmission frequency ftx. That is, the signal component at the reception frequency frx is the above-mentioned reception frequency signal, while the signal component at the transmission frequency ftx is the transmission frequency signal having leaked through the reception filter 24 as described above.

The signal inputted to the input port l of the directional coupler 19 is combined with a signal inputted from the vector adjuster 21 to the input port k of the directional coupler 19, and then outputted through the output port m of the directional coupler 19. FIG. 3(c) shows the frequency distribution of the signal inputted to the input port k of the directional coupler 19. As seen from FIG. 3(b), the signal inputted to the input port k has a signal component at the transmission frequency ftx. Here, in FIG. 3(c), the signal component at the transmission frequency ftx is illustrated by an arrow of the direction reverse to that of the arrow illustrating the transmission frequency ftx signal component in FIG. 3(b). This indicates that the transmission frequency ftx signal component in FIG. 3(c) is in the reverse phase (the phase difference is 180°) to the transmission frequency ftx signal component in FIG. 3(b).

That is, the transmission frequency ftx signal component of the signal inputted to the input port l of the directional coupler 19 is substantially at equal amplitude and reverse phase relative to the signal inputted to the input port k of the directional coupler 19.

Accordingly, when the signal inputted to the input port l and the signal inputted to the input port k are combined by the directional coupler 19, the transmission frequency ftx signal components substantially at equal amplitude and reverse phase are cancelled out and thereby does not appear in the output port m of the directional coupler 19. Even in case that the signal components are not completely cancelled out, the signal component appearing in the output port m of the directional coupler 19 is reduced sufficiently. Thus, the frequency distribution of the signal appearing in the output port m of the directional coupler 19 is as shown in FIG. 3(d). As seen from FIG. 3(d), the reception frequency frx signal component suffers almost no loss, whereas the transmission frequency ftx signal component is reduced sufficiently.

The signal outputted from the output port m of the directional coupler 19 is provided to the input port n of the directional coupler 20. The signal is bifurcated by the directional coupler 20, and thereby outputted respectively through the output ports o and p.

The signal outputted from the output port o is provided to the vector detector 22. As described above in the description of the operation of transmission, the vector detector 22 receives also the transmission frequency signal outputted from the output port j of the directional coupler 18.

The vector detector 22 outputs, to the vector adjuster 21, control signals which contain information on the amplitude difference and the phase difference between the transmission frequency signal outputted from the output port j and the signal outputted from the output port o.

More specifically, the vector detector 22 has a configuration equivalent to that of a quadrature demodulator. The vector detector 22 processes the transmission frequency signal outputted from the output port j, as a reception signal, and processes the signal outputted from the output port o, as a local oscillation frequency signal used for demodulation. As a result, the vector detector 22 outputs an I signal and a Q signal demodulated from these two signals, to the vector adjuster 21. These I signal and Q signal constitute the above-mentioned control signals, and hence contain the information on the amplitude difference and the phase difference.

The vector adjuster 21 receives the above-mentioned signals containing the information on the amplitude difference and the phase difference, and thereby adjusts the amplitude and the phase of the signal outputted from the output port j such that the amplitude difference indicated in the control signal becomes substantially zero and that the phase difference becomes substantially the reverse phase (the phase difference is 180°).

More specifically, the vector adjuster 21 has a configuration equivalent to that of a quadrature modulator. The vector adjuster 21 processes the transmission frequency signal outputted from the output port j, as a carrier wave, and processes the control signals outputted from the vector detector 22, as an I signal and a Q signal. That is, the vector adjuster 21 performs quadrature modulation on the transmission frequency signal outputted from the output port j, with the I signal and the Q signal inputted from the vector detector 22. This modulated signal is provided from the vector adjuster 21 to the input port k of the directional coupler 19.

In the modulation where the vector adjuster 21 modulates the signal outputted from the output port j with the control signals outputted from the vector detector 22, when the amplitude difference between the transmission frequency signal outputted from the output port j and the signal outputted from the output port o of the directional coupler 20is large, the vector adjuster 21 performs modulation such as to reduce the amplitude difference. When the phase difference between these signals is far from the reverse phase state, the vector adjuster 21 performs modulation such as to bring the phase difference close to the reverse phase state. As a result, the signal inputted from the vector adjuster 21 to the input port k and the transmission frequency signal component of the signal inputted to the input port l are adjusted to be substantially at equal amplitude and reverse phase.

By virtue of the use of the vector detector 22 and the vector adjuster 21, for example, even when a hand touches the antenna 7 or a human body approaches the antenna 7, and accordingly even when the load to the antenna 7 changes, the influence of the load change is cancelled out, whereby the transmission frequency signal component of the signal inputted to the input port l and the signal inputted to the input port k are always maintained substantially at equal amplitude and reverse phase.

Accordingly, even in case of a load change in the antenna 7, the load change is prevented from causing an interference wave at the transmission frequency ftx in the output port m of the directional coupler 19.

On the other hand, the signal outputted from the output port p of the directional coupler 20 is provided to the low-noise amplifier 13 of the receiving circuit 3. In the signal inputted to the low-noise amplifier 13, the transmission frequency ftx signal component is reduced sufficiently. This protects the receiving circuit 3 from possible adverse influences, for example, that the low-noise amplifier 13 is saturated by the transmission frequency ftx signal component possibly inputted to the low-noise amplifier 13 and thereby serving as an interference wave.

In the receiving circuit 3, the low-noise amplifier 13 amplifies the inputted reception frequency signal, and then outputs the signal to the band pass filter 14. Unnecessary frequency components in the reception frequency signal inputted to the band pass filter 14 are reduced here. The reception frequency signal is then provided to the mixer 15. The mixer 15 combines the local oscillation signal inputted from the local oscillator 4 and the reception frequency signal inputted from the band pass filter 14, into an intermediate frequency signal. Distortion components in the intermediate frequency signal outputted from the mixer 15 are reduced by the band pass filter 16. Then, the intermediate frequency signal is provided to the demodulator 17, and thereby demodulated into a baseband signal in the demodulator 17. The demodulated baseband signal is provided to the baseband section (not shown).

As such, even in case that the transmission frequency ftx and the reception frequency frx are close to each other, the use of the radio interference suppression circuit 5 reduces the leakage of the transmission frequency signal into the receiving circuit.

The use of the radio interference suppression circuit 5 also permits the use of small filters as the reception filter 24 and the transmission filter 23. This permits further miniaturization of the antenna multiplexer 6 and cellular phone terminal 1 substantially without an increase in the loss in the reception filter 24. Thus, obtained is a cellular phone terminal 1 having a good reception sensitivity.

Further, the radio interference suppression circuit 5 reduces the transmission frequency signal component serving as self transmission interference, from the signal inputted to the receiving circuit 3. This avoids the necessity of a steep characteristic in the bandpass filter 14 in the receiving circuit 3, and hence permits the use of a small filter having a low loss at the pass band. Further, avoided is the necessity of the use of an amplifier having a high saturation level, as the low-noise amplifier 13. This permits the miniaturization of the cellular phone terminal 1, whereby obtained is a cellular phone terminal 1 having a low power consumption and a good reception sensitivity.

In a communication scheme such as W-CDMA, when the reception field intensity is strong in a location close to a base station and hence the reception condition is good, the cellular phone terminal 1 adjusts the transmission power level thereof to be low. On the contrary, when the reception field intensity is weak in a location far from a base station and hence the reception condition is poor, the cellular phone terminal 1 adjusts the transmission power level thereof to be high. Thus, when the transmission power level of the cellular phone terminal 1 is set lower than a predetermined level, the influence of self transmission interference is substantially negligible, and hence the operation of the radio interference suppression circuit 5 is unnecessary. In this case, a control circuit (not shown) provided in the cellular phone terminal 1 controls the vector adjuster 21 and the vector detector 22 to stop the operation. As a result, when the transmission power level is lower than the predetermined level, and hence when the vector adjuster 21 and the vector detector 22 are stopped, the power consumption is reduced.

Further, as described above, the vector detector 22 detects the amplitude difference and the phase difference between the signal outputted from the output port j and the signal outputted from the output port o, and thereby outputs the control signals, while the vector adjuster 21 performs adjustment such that the signal inputted to the input port l and the signal inputted to the input port k become at equal amplitude and reverse phase. Such as, the radio interference suppression circuit 5 performs a feedback control. Thus, in some cases, some amount of time can be necessary before the feedback control reaches stability. In such cases, the cellular phone terminal 1 may operate as follows.

That is, the radio interference suppression circuit 5 may be provided with a table of corresponding a transmission power and a temperature to a vector adjustment amount. In the initial stage of communication, instead of the above-mentioned control that the control signals from the vector detector 22 are inputted to the vector adjuster 21, the control signals may be generated on the basis of the table, and then inputted to the vector adjuster 21. Then, when every circuit in the cellular phone terminal 1 has reached stability, the control signals from the vector detector 22 are inputted to the vector adjuster 21, whereby the feedback operation is started. As such, in case that in the initial stage, control signals are generated on the basis of a table of corresponding a transmission power and a temperature to a vector adjustment amount, the feedback control in the cellular phone terminal 1 reaches stability in a short time.

The present embodiment has been described for the case that the directional coupler 20 is provided between the directional coupler 19 and the low-noise amplifier 13 of the receiving circuit 3. However, the invention is not limited to this. The directional coupler 20 may be provided between the reception filter 24 and the directional coupler 19. Alternatively, the directional coupler 20 may be provided between the low-noise amplifier 13 and the band pass filter 14, or alternatively between the band pass filter 14 and the mixer 15. That is, the directional coupler 20 may be provided anywhere in the upstream of the mixer 15 of the receiving circuit 3. These alternatively configurations have the same effect as the present embodiment.

The present embodiment has been described for the case that the cellular phone terminal 1 performs the radio communication according to the W-CDMA scheme. However, the invention is not limited to this. The cellular phone terminal 1 according to the present embodiment may perform the radio communication according to a communication scheme other than W-CDMA, as long as the communication scheme used implements duplex transmission where transmission and reception are performed simultaneously.

The cellular phone terminal 1 according to the present embodiment does not need to continuously perform duplex transmission during the radio communication with the base station. That is, the communication scheme used may be a scheme in which duplex transmission is performed in a part of the duration of radio communication with the base station.

This situation holds even in case that the cellular phone terminal 1 is capable of communicating directly with another cell phone terminal 1 without relay through the base stations.

That is, the cellular phone terminal 1 according to the present embodiment is a cellular phone terminal 1 of performing duplex transmission in all or part of the communication.

The transmitting circuit 2 and the receiving circuit 3 according to the present embodiment may have another circuit configuration.

As described above, the invention provides: a radio interference suppression circuit used in a communication scheme in which duplex transmission is performed in all or part of the communication, and capable of reducing the leakage of a transmission frequency signal into a receiving circuit; and an antenna multiplexer, a transceiver circuit, and a communication apparatus using the same.

The invention further provides: a radio interference suppression circuit used in a communication scheme in which duplex transmission is performed in all or part of the communication, and capable of reducing the leakage of a transmission frequency signal into a receiving circuit without causing substantial increase in the reception loss at the reception frequency and in the size of a reception filter; and an antenna multiplexer, a transceiver circuit, and a communication apparatus using the same.

What is claimed is:

1. A radio interference suppression circuit used in a radio circuit performing duplex transmission in all or part of communication, comprising:
first branching means of receiving a transmission frequency signal and then bifurcating and outputting the signal into at least two outputs at a predetermined branching ratio; and
second branching means which acquires, through one input thereof, a signal containing a received reception frequency signal and the leakage signal component of a transmission frequency signal to be transmitted, and acquires, through the other input thereof, the transmission frequency signal outputted from one output of said first branching means, and which combines and outputs these acquired signals at a predetermined combining ratio; wherein:
a transmission frequency signal to be transmitted is outputted from an other output of said first branching means;
the signal from said second branching means is inputted to a receiving circuit; and
the leakage signal component of said transmission frequency signal to be transmitted which is contained in said signal inputted through the one input of said second branching means and said transmission frequency signal inputted through the other input of said second branching means are adjusted to be substantially of equal amplitude and reversed phase.

2. A radio interference suppression circuit according to claim 1, comprising a vector adjuster one end of which is connected to the one output of said first branching means and the other end of which is connected to the other input of said second branching means, whereby
said vector adjuster performs said adjustment.

3. A radio interference suppression circuit according to claim 2, comprising a vector detector of detecting the amplitude difference and the phase difference of a signal inputted to said radio interference suppression circuit, a signal from the output of said second branching means, a signal from the output of a low-noise amplifier of said receiving circuit, or a signal from any circuit portion between the input of said receiving circuit and an intermediate frequency converter of said receiving circuit, relative to a signal from the one output of said first branching means, whereby
said vector adjuster performs said adjustment on the basis of said detected amplitude difference and phase difference.

4. A radio interference suppression circuit according to claim 3, wherein
said vector detector is composed of a quadrature demodulator, and wherein
said vector adjuster is composed of a quadrature modulator.

5. A radio interference suppression circuit according to claim 1, comprising controlling means of controlling said adjustment to stop when the level of said transmission signal is lower than a predetermined level.

6. A radio interference suppression circuit according to claim 1, comprising a table of corresponding an output level and a temperature to a vector adjustment amount, whereby
said vector adjustment amount which is obtained from said table corresponding to the level of said transmission signal and to a detected temperature and which corresponds to said output level and said temperature is used as the initial value for said adjustment.

7. A radio interference suppression circuit according to any one of claims 1-6, wherein said first branching means comprises a directional coupler, a Wilkinson divider, a resistor divider, or a capacitive coupling.

8. A radio interference suppression circuit according to any one of claims 1-6, wherein said second branching means comprises a directional coupler, a Wilkinson combiner, a resistor combiner, or a capacitive coupling.

9. An antenna multiplexer used in a radio circuit performing duplex transmission in all or part of communication, comprising:
a radio interference suppression circuit according to any one of claims 1-6;
a transmission filter connected to the other output of said first branching means of said radio interference suppression circuit; and
a reception filter connected to the input of said second branching means.

10. A communication apparatus using a radio circuit performing duplex transmission in all or part of communication, comprising:
a transmitting circuit of outputting a transmission signal;
a receiving circuit of receiving a reception signal;
an antenna multiplexer; and
a radio interference suppression circuit connected to said antenna multiplexer, said transmitting circuit, and said receiving circuit; wherein
said radio interference suppression circuit comprises a radio interference suppression circuit according to any one of claims 1-6.

11. A transceiver circuit used in a radio circuit performing duplex transmission in all or part of communication, comprising:
a transmitting circuit of outputting a transmission signal;
a receiving circuit of receiving a reception signal; and
a radio interference suppression circuit connected to said transmitting circuit and said receiving circuit; wherein
said radio interference suppression circuit comprises a radio interference suppression circuit according to any one of claims 1-6.

12. A radio interference suppression method comprising the steps of: branching a portion of a transmission frequency signal outputted from a transmitting circuit; and adding (1) a transmission frequency signal having leaked into a receiving circuit through a transmission-reception branch point which is a connection point between a transmission system and a reception system, and said branched portion of the transmission frequency signal to each other substantially with each having equal amplitude and reversed phase.
